(19) United States
(12) Patent Application Publication
(10) Pub. No.: US 2015/0081761 A1
(43) Pub. Date: Mar. 19, 2015

(54) DETERMINING FORMAT COMPATIBILITY ACROSS A DATA PROCESSING DEVICE AND ANOTHER DATA PROCESSING DEVICE PRIOR TO TRANSFER OF A MULTIMEDIA FILE THEREBETWEEN

(71) Applicant: NVIDIA Corporation, Santa Clara, CA (US)

(72) Inventors: Shounak Santosh Deshpande, Pune (IN); Rahul Ulhas Marathe, Pune (IN)

(73) Assignee: NVIDIA Corporation, Santa Clara, CA (US)

(21) Appl. No.: 14/028,574

(22) Filed: Sep. 17, 2013

(51) Int. Cl. H04L 29/08

(52) U.S. Cl. CPC H04L 67/06; H04L 67/2823
USPC 709/202

(57) ABSTRACT

A method includes executing an instance of a process on a data processing device and another data processing device, and setting up a Personal Area Network (PAN) through registering or pairing the another data processing device with the data processing device based on an identifier thereof. The method also includes initiating transfer of a multimedia file from the data processing device to the another data processing device through the instance of the process executing on the data processing device, and transmitting, metadata associated with the multimedia file from the data processing device to the another data processing device. Further, the method includes determining format compatibility of the multimedia file with the another data processing device thereat based on the metadata and a list of supported formats available in the another data processing device through a continued execution of the instance of the process on the another data processing device.

### FIELD OF TECHNOLOGY

This disclosure relates generally to data processing devices and, more particularly, to determining format compatibility across a data processing device and another data processing device prior to transfer of a multimedia file therebetween.

### BACKGROUND

A data processing device (e.g., a mobile phone, a tablet) may include a multimedia file (e.g., a video file, an audio file, a text file) stored therein. A user of the data processing device may desire rendering of the multimedia file on another data processing device (e.g., a laptop). For the aforementioned purpose, the user may have to transfer the multimedia file to the another data processing device. Further, if the multimedia file is not compatible with the another data processing device, the user may have to perform format conversion (e.g., on a server, download appropriate software) of the multimedia file prior to the rendering thereof. The aforementioned process may inconvenience the user.

### SUMMARY

Disclosed are a method, a device and/or a system of determining format compatibility across a data processing device and another data processing device prior to transfer of a multimedia file therebetween.

In one aspect, a method includes executing an instance of a process on each of a data processing device and another data processing device, and setting up a Personal Area Network (PAN) through registering or pairing the another data processing device with the data processing device based on an identifier thereof utilizing a first communication link of the PAN to enable data communication therebetween. The method also includes initiating transfer of a multimedia file from a memory of the data processing device to the another data processing device through the instance of the process executing on the data processing device utilizing a second communication link of the PAN. The second communication link is a same communication link as the first communication link or different from the first communication link.

Further, the method includes transmitting, in accordance with the initiation of the transfer, metadata associated with the multimedia file from the data processing device to the another data processing device, and determining format compatibility of the multimedia file with the another data processing device thereat based on the metadata and a list of supported formats available in a memory of the another data processing device through a continued execution of the instance of the process on the another data processing device.

In another aspect, a non-transitory medium, readable through a data processing device and another data processing device and including instructions embodied therein that are executable through the data processing device and the another data processing device, is disclosed. The non-transitory medium includes instructions to execute an instance of a process on each of the data processing device and the another data processing device, and instructions to set up a PAN through registering or pairing the another data processing device with the data processing device based on an identifier thereof utilizing a first communication link of the PAN to enable data communication therebetween. The non-transitory medium also includes instructions to initiate transfer of a multimedia file from a memory of the data processing device to the another data processing device through the instance of the process executing on the data processing device utilizing a second communication link of the PAN. The second communication link is a same communication link as the first communication link or different from the first communication link.

Further, the non-transitory medium includes instructions to transmit, in accordance with the initiation of the transfer, metadata associated with the multimedia file from the data processing device to the another data processing device, and instructions to determine format compatibility of the multimedia file with the another data processing device thereat based on the metadata and a list of supported formats available in a memory of the another data processing device through a continued execution of the instance of the process on the another data processing device.

In yet another aspect, a data communication system includes a data processing device and another data processing device. Each of the data processing device and the another data processing device executes an instance of a process thereon. The another data processing device is registered or paired with the data processing device based on an identifier thereof to set up a PAN. A first communication link of the PAN is utilized to enable data communication between the data processing device and the another data processing device. The instance of the process executing on the data processing device is configured to initiate transfer of a multimedia file from a memory of the data processing device to the another data processing device utilizing a second communication link of the PAN. The second communication link is a same communication link as the first communication link or different from the first communication link,

In accordance with the initiation of the transfer, the data processing device is configured to transmit metadata associated with the multimedia file to the another data processing device. The another data processing device is configured to determine format compatibility of the multimedia file therewith based on the metadata and a list of supported formats available in a memory thereof through a continued execution of the instance of the process thereon.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data communication system, according to one or more embodiments.

FIG. 2 is a schematic view of data processing devices of the data communication system of FIG. 1 with corresponding Near Field Communication (NFC) circuits.

FIG. 3 is a schematic view of an external data processing device configured to perform format conversion of a multimedia file on behalf of the data processing device(s) of the data communication system of FIG. 1.

FIG. 4 is a flowchart detailing the operations involved in transfer of the multimedia file between the data processing devices of the data communication system of FIG. 1, according to one or more embodiments.

FIG. 5 is a process flow diagram detailing the operations involved in determining format compatibility across the data processing devices of the data communication system of FIG. 1 prior to transfer of the multimedia file therebetween, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of determining format compatibility across a data processing device and another data processing device prior to transfer of a multimedia file therebetween. Although the present embodiments have been described with reference to specific example embodiments, it will be evident that various modifications and changes may be made to these embodiments without departing from the broader spirit and scope of the various embodiments.

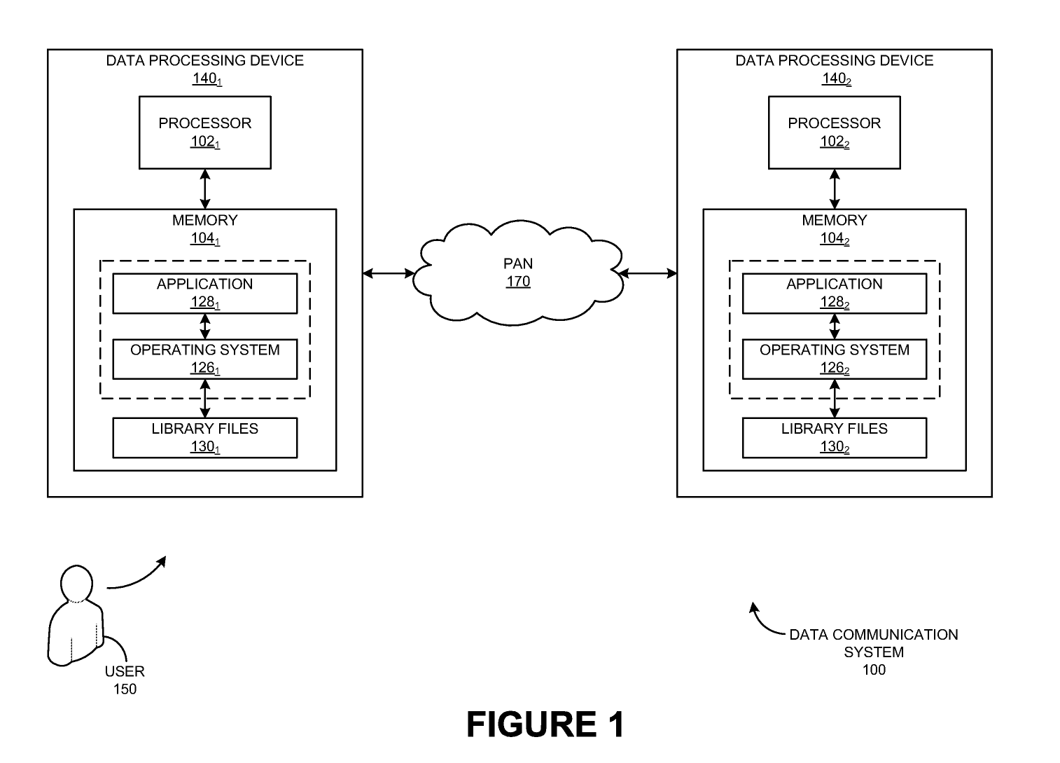

FIG. 1 shows a data communication system 100, according to one or more embodiments. In one or more embodiments, data communication system 100 may include a data processing device 140₁ configured to be communicatively coupled to another data processing device 140₂ for the purpose of transferring one or more multimedia file(s) (e.g., video file, audio file, text file) therebetween. In one or more embodiments, the aforementioned data processing devices 140₁₋₂ may share a common user 150 therebetween. Alternately, data processing device 140₁ may be associated with one user (e.g., user 150) and data processing device 140₂ may be associated with another user (not shown).

For example, one data processing device 140₁ may be a tablet, a netbook or a mobile phone and data processing device 140₂ may be a smart television or a laptop including a display unit. Alternately, both data processing device 140₁ and data processing device 140₂ may be a same type of a data processing device. Other forms of data processing devices 140₁₋₂ are within the scope of the exemplary embodiments discussed herein.

In one or more embodiments, each data processing device 140₁₋₂ may include a processor 102₁₋₂ (e.g., a Central Processing Unit (CPU), a Graphics Processing Unit (GPU) and/or a low-end microcontroller) communicatively coupled to a memory 104₁₋₂ (e.g., a volatile memory and/or a non-volatile memory); memory 104₁₋₂ may include storage locations configured to be addressable through processor 102₁₋₂. In one or more embodiments, each data processing device 140₁₋₂ may execute an operating system 126₁₋₂ thereon. In one or more embodiments, operating system 126₁ of data processing device 140₁ may be different from operating system 126₂ of data processing device 140₂. In one or more other embodiments, two data processing devices (e.g., data processing device 140₁ and data processing device 140₂) may share a same operating system.

In one or more embodiments, each data processing device 140₁₋₂ may execute an instance of an application 128₁₋₂ thereon. FIG. 1 shows operating system 126₁₋₂ and application 128₁₋₂ as being stored in memory 104₁₋₂. In one or more embodiments, application 128₁₋₂ may have a set of instructions associated with enabling coupling between data processing device 140₁ and data processing device 140₂, determining compatibility of a format of one or more multimedia file(s) (to be discussed below) between data processing devices 140₁₋₂ and/or format conversion of the one or more multimedia file(s) to convenience compatibility thereof across data processing devices 140₁₋₂. In one or more embodiments, for the aforementioned purpose, a non-transitory machine-readable medium including but not limited to a Compact Disc (CD), a Digital Video Disc (DVD) and a Blu-ray Disc® may include appropriate instructions embodied therein that can be executable through each data processing device 140₁₋₂; application 128₁₋₂ may, therefore, be loaded onto each data processing device 140₁₋₂.

Alternately, the abovementioned set of instructions may be downloaded from, for example, the Internet and installed on each data processing device 140₁₋₂. In one or more embodiments, data processing device 140₁ may be coupled to data processing device 140₂ through a short-range wired or wireless communication link such as a Personal Area Network (PAN) 170 (e.g., based on Wi-Fi Direct™, Bluetooth®, Near Field Communication (NFC)). In one or more embodiments, in case of data processing device 140₁ and data processing device 140₂ having dissimilar operating systems, application 128₁ and/or application 128₂ may be packaged with appropriate library files 130₁₋₂ to enable compatibility of data communication therebetween; FIG. 1 shows both application 128₁ and application 128₂ being packaged with library files 130₁ and library files 130₂ respectively.

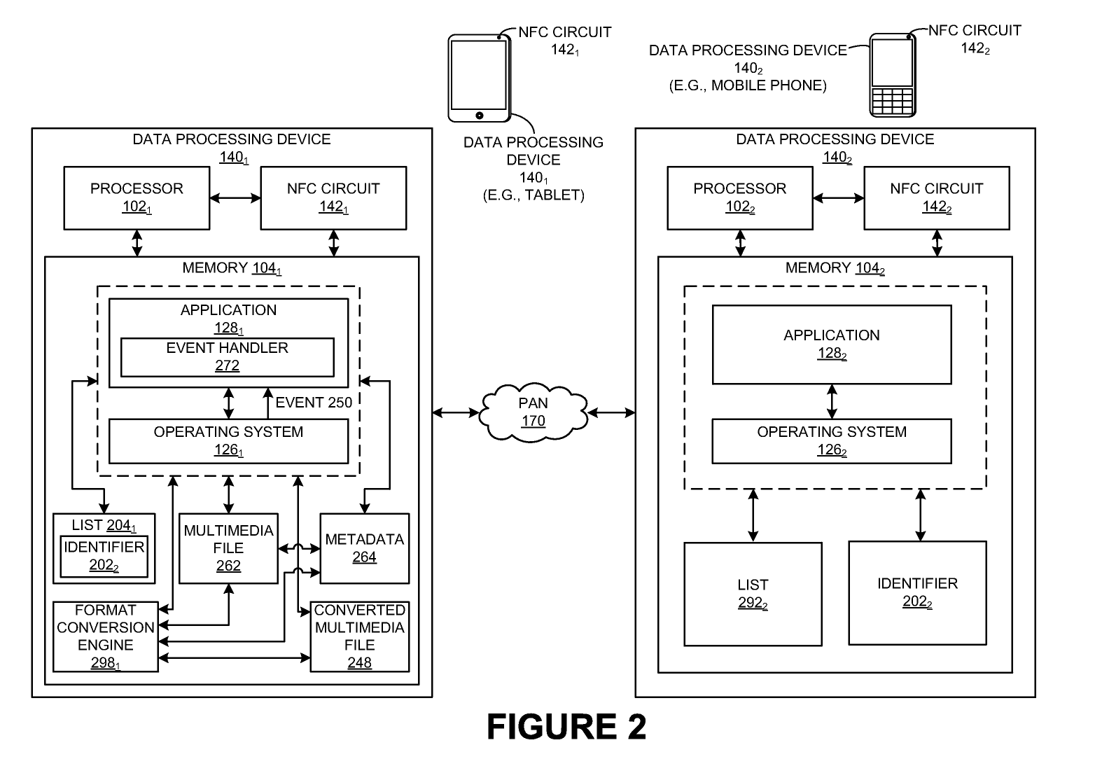

In one or more embodiments, data processing device 140₂ may first be registered with data processing device 140₁ prior to enabling the transfer of multimedia file(s) therebetween. In one example embodiment, data processing device 140₂ may be paired with data processing device 140₁ through an NFC based communication link. For the aforementioned purpose, each data processing device 140₁₋₂ may be NFC enabled. FIG. 2 shows data processing device 140₁ and data processing device 140₂ with corresponding NFC circuit 142₁ and NFC circuit 142₂ respectively.

As part of the pairing/registration process, data processing device 140₁ and data processing device 140₂ may be brought in close proximity (e.g., “bumped” with each other) to one another; an identifier 202₂ of data processing device 140₂ may be read through NFC circuit 142₁ of data processing device 140₁; identifier 202₂ may be hard-coded into NFC circuit 142₂ of data processing device 140₂. Identifier 202₂ may then be stored in memory 104₁ of data processing device 140₁ in a list 204₁ of data processing devices (including data processing device 140₂) configured to communicate with data processing device 140₁. One or more other data processing devices (not shown) may also be paired with data processing device 140₁ in a similar manner to enable identifiers thereof being stored in list 204₁. The identifiers may enable identification of data processing devices when within range of communication of data processing device 140₁.

It should be noted that the communication link utilized for registration (e.g., NFC, Bluetooth®) may be different from the communication link (e.g., Wi-Fi Direct™) utilized for multimedia file transfer and/or multimedia file format conversion/compatibility determination. Alternately, the same communication link (e.g., NFC, Bluetooth®) may be employed for the registration, the multimedia file format conversion/compatibility determination and the multimedia file transfer. Also, the abovementioned pairing process is merely for example purposes; other forms of registration are within the scope of the exemplary embodiments. Further, it is possible for data processing device 140₁ to be registered with data processing device 140₂ based on an identifier thereof.

In one or more embodiments, through the registration of data processing device 140₂ with data processing device 140₁, user 150 may set up a personal network to transfer multimedia file(s) therebetween. In one example implementation, data processing device 140₁ may be a tablet and data processing device 140₂ may be a mobile phone (data processing device 140₂) being registered with the tablet (data processing device 140₁). In the aforementioned example implementation, the transfer of the one or more multimedia file(s) may occur immediately following the registration process. Alternately, the transfer of the one or more multimedia file(s) may occur upon initiation through user 150.

It should be noted that application 128₁ and application 128₂ may be instances of a dedicated application executing on data processing device 140₁ and data processing device 140₂ respectively to enable the transfer of the one or more multimedia file(s), the determination of compatibility of the one or more multimedia file(s) across data processing devices 140₁₋₂ and/or the format conversion thereof (to be discussed below) or an existing application (e.g., provided with a new plug-in). To generalize, application 128₁ and application 128₂ may be subsets of a process (e.g., a daemon process) responsible for data management associated with the format compatibility determination, the format conversion of the one or more multimedia file(s) and/or the subsequent transfer thereof (or, vice versa).

FIG. 2 shows multimedia file(s) 262 being stored in memory 104₁ of data processing device 140₁. In one or more embodiments, user 150 may select a multimedia file 262 to be transferred to data processing device 140₂. The selection of multimedia file 262 through a file system implemented in data processing device 140₁ may cause operating system 126₁ to generate an event 250; said event 250 may be interpretable through application 128₁ (e.g., through an event handler implemented in application 128₁ and/or operating system 126₁; FIG. 2 shows event handler 272 as being implemented in application 128₁). Following the interpretation of event 250, application 128₁ may initiate transfer of metadata 264 (e.g., file type) associated with multimedia file 262 to data processing device 140₂.

It is obvious that the transfer of metadata 264 may be accompanied by some kind of handshaking. In one or more embodiments, upon receipt of metadata 264 at data processing device 140₂, application 128₂ (e.g., through processor 102₂) may determine whether multimedia file 262 is in a format compatible with formats supported through data processing device 140₂. In one or more embodiments, the aforementioned list of formats may be available through operating system 126₂ executing on data processing device 140₂. FIG. 2 shows the list of supported formats (e.g., list 292₂) being stored in memory 104₂. In one or more embodiments, based on list 292₂, application 128₂ (e.g., through processor 102₂) may determine whether data processing device 140₂ natively supports the format of multimedia file 262. In one or more embodiments, if yes, application 128₂ may transmit an appropriate communication (e.g., a message, a signal) to application 128₁ executing on data processing device 140₁; multimedia file 262 may then be transferred from data processing device 140₁ to data processing device 140₂.

In one or more embodiments, if the format of multimedia file 262 is not supported through data processing device 140₂, data processing device 140₂ may transfer list 292₂ to data processing device 140₁ through PAN 170. In one or more embodiments, list 292₂ may be interpreted through application 128₁ and/or operating system 126₁, based on which data processing device 140₁ is configured to determine whether conversion of multimedia file 262 to a format compatible with data processing device 140₂ is possible thereat. For example, installation of an appropriate format conversion capability (e.g., a format conversion engine 298₁ shows as being stored in memory 104₁ to be executed through processor 102₁) in data processing device 140₁ may cause operating system 126₁ to be aware of said capability.

In one or more embodiments, application 128₁ may be configured to determine (e.g., through execution thereof on processor 102₁) the format conversion capability based on operating system 126₁ being aware of the format conversion capability. In one or more embodiments, if application 128₁ deems data processing device 140₁ to possess the format conversion capability, application 128₁ may initiate conversion of multimedia file 262 through execution of format conversion engine 298₁. The converted version (e.g., converted multimedia file 248) of multimedia file 262 may then be transferred to data processing device 140₂.

In one or more embodiments, if application 128₁ deems data processing device 140₁ to be incapable of the appropriate format conversion (e.g., through absence of format conversion engine 298₁ or corruption thereof), application 128₁ may be configured to enable transfer of multimedia file 262 to data processing device 140₂ as is or cancel the request initiated through data processing device 140₁. It should be noted that once application 128₁ deems that data processing device 140₁ is capable of the format conversion, a notification to user 150 may be generated through application 128₁ to enable user 150 confirm the format conversion and the subsequent transfer of converted multimedia file 248 through PAN 170.

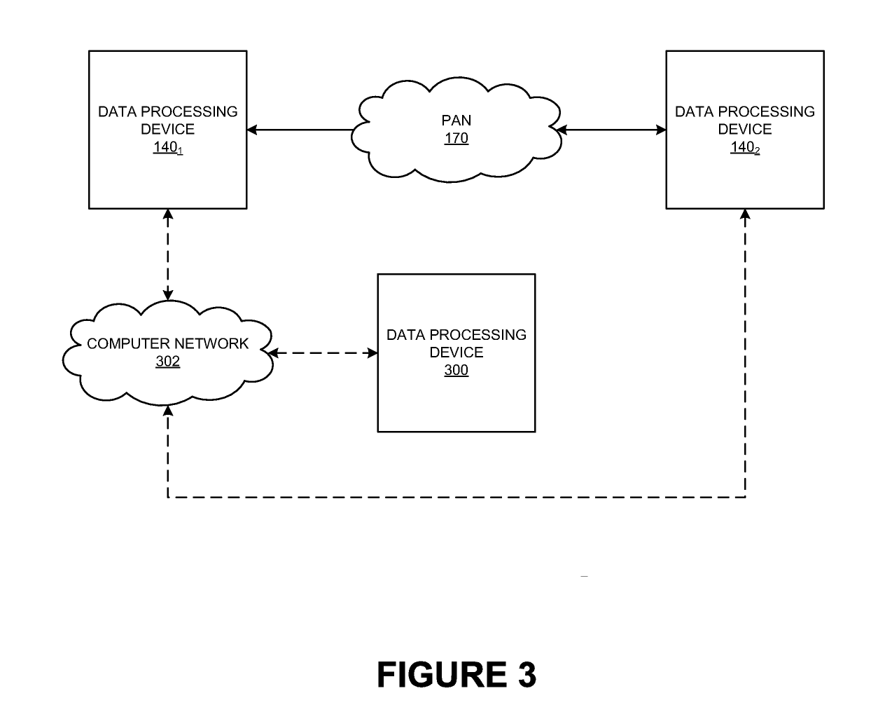

In one or more embodiments, appropriate notifications may be generated when the format conversion and/or the transfer of converted multimedia file 248 fails. FIG. 3 shows an external data processing device 300 (e.g., yet another data processing device, a data processing device such as a server; the server may perform the format conversion as a service (e.g., a cloud service)) configured to perform the format conversion on behalf of data processing device 140₁ and/or data processing device 140₂. Here, in one or more embodiments, when application 128₁ deems that format conversion is not possible at data processing device 140₁, application 128₁ may initiate transfer of multimedia file 262 for conversion at data processing device 300. It should be noted that data processing device 300 may directly transfer the converted multimedia file to data processing device 140₂ (e.g., through PAN 170 or another computer network 302 (e.g., Internet, a Local Area Network (LAN), a Wide Area Network (WAN)) shown in FIG. 3), or transfer the converted multimedia file to data processing device 140₁, which, in turn, transfers the converted file to data processing device 140₂.

Alternately, in one or more embodiments, following transfer of metadata 264 to data processing device 140₂, application 128₂ may determine that data processing device 140₂ natively does not support a format of multimedia file 262 based on metadata 264 (and list 292₂). Here, in one or more embodiments, application 128₂ may initiate transfer of multimedia file 262 to data processing device 140₂ and the subsequent conversion of multimedia file 262 to a format compatible therewith through data processing device 300.

It should be noted that implementations of the concepts associated with the exemplary embodiments are not merely limited to non-real-time multimedia file transfer. In one example embodiment, data processing device 140₁ may be a handheld device such as a video camera and data processing device 140₂ may be a smart television. Data processing device 140₁ may stream video to data processing device 140₂ using an NFC add-on adapter. As the smart television may support a limited number of video formats, providing a capability to encode video to a format supported by the smart television may lead to better user experience. For example, the smart television may include information related to supported video formats (e.g., list 292₂) in firmware or as an Extended Display Identification Data (EDID) data structure (e.g., stored in memory 104₂).

Further, as discussed above, it should be noted that the registration/pairing of data processing devices may utilize one communication link (e.g., NFC) and the multimedia file transfer/determination of format compatibility may utilize another communication link (e.g., Bluetooth®) therefor. Alternately, the aforementioned operations may utilize the same communication link. Also, it is to be noted that NFC utilization is associated with the preferred embodiment for robustness and speed of transfer thereof; for example, NFC is faster than Bluetooth®; also unlike Wi-Fi®, NFC eliminates the external factor in communication.

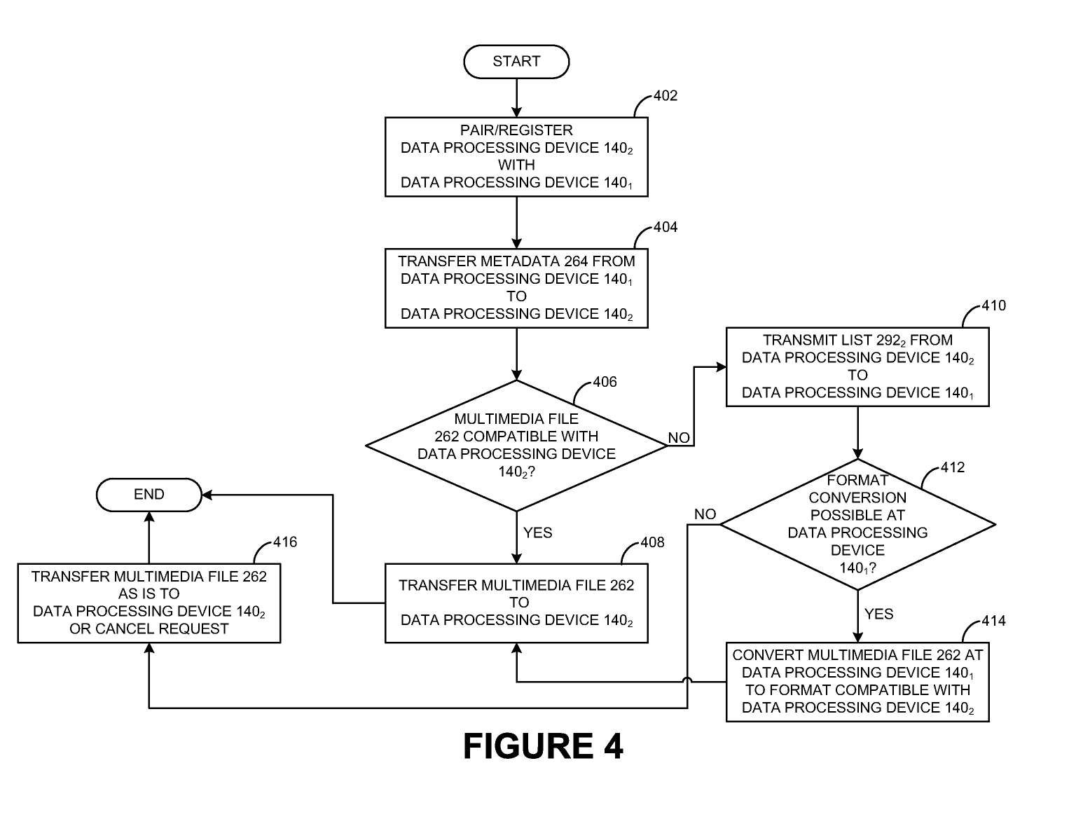

FIG. 4 shows a flowchart summarizing the operations involved in the abovementioned transfer of multimedia file 262 between data processing device 140₁ and data processing device 140₂, according to one or more embodiments. In one or more embodiments, operation 402 may involve pairing/registering data processing device 140₂ with data processing device 140₁ through a communication link (e.g., NFC). In one or more embodiments, operation 404 may involve transferring metadata 264 associated with multimedia file 262 from data processing device 140₁ to data processing device 140₂. In one or more embodiments, operation 406 may involve checking as to whether multimedia file 262 is compatible with data processing device 140₂ based on list 292₂ and the received metadata 264. In one or more embodiments, if yes, operation 408 may involve transferring multimedia file 262 from data processing device 140₁ to data processing device 140₂.

In one or more embodiments, if the result of operation 406 is a no, operation 410 may involve transmitting list 292₂ from data processing device 140₂ to data processing device 140₁. In one or more embodiments, operation 412 may involve determining whether an appropriate format conversion of multimedia file 262 is possible at data processing device 140₁ based on interpretation of list 292₂ thereat. In one or more embodiments, if yes, operation 414 may involve conversion of multimedia file 262 at data processing device 140₁ to a format compatible with data processing device 140₂. In one or more embodiments, control may then pass to operation 408. In one or more embodiments, if the result of operation 412 is a no, operation 416 may involve transfer of multimedia file 262 to data processing device 140₂ as is (analogous to operation 406) or cancellation of the request for file transfer initiated through data processing device 140₁.

It is obvious that the format conversion/file transfer process is not limited to the operations discussed with regard to FIG. 4 and that other operations (e.g., discussed with regard to FIG. 3) are also within the scope of the exemplary embodiments discussed herein. Further, it should be noted that it is not necessary for data processing device 140₂ to execute operating system 126₂. List 292₂, for example, may be made available in memory 104₂ of data processing device 140₂. Still further, it may not be necessary to determine format compatibility at data processing device 140₂. List 292₂, for example, may be transmitted to data processing device 140₁ to determine format compatibility of multimedia file 262 with data processing device 140₂ at data processing device 140₁ based on list 292₂ and metadata 264. Subsequent format conversion(s) may then proceed as discussed above.

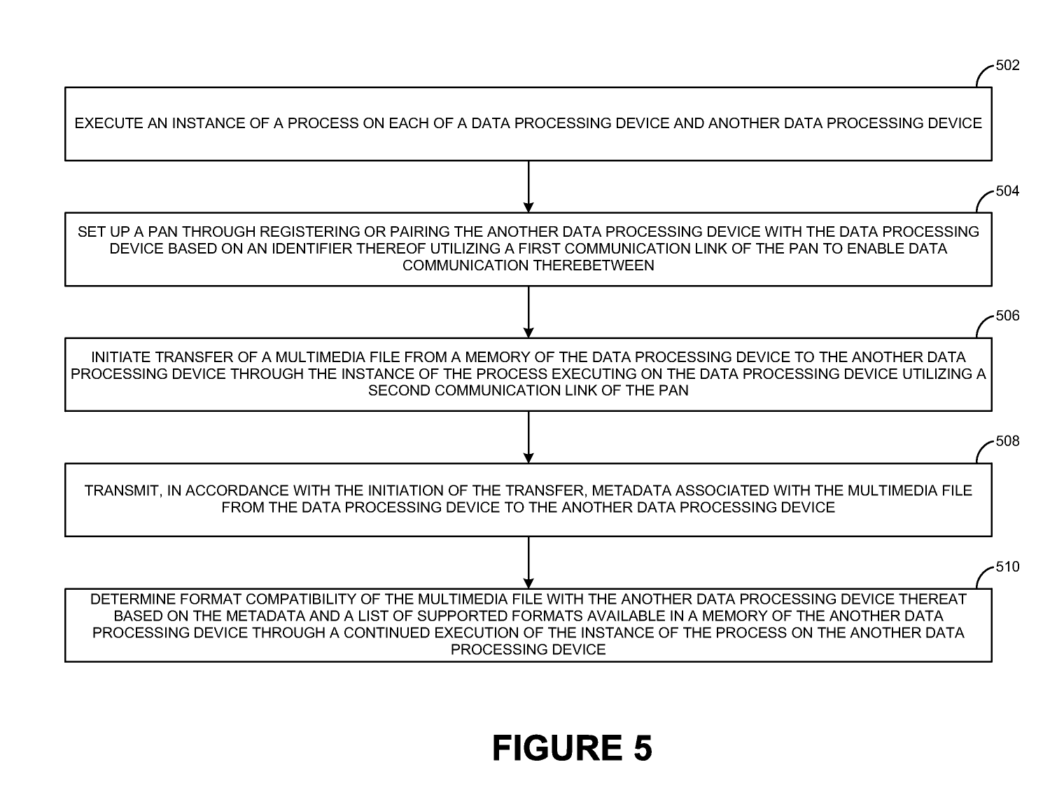

FIG. 5 shows a process flow diagram detailing the operations involved in determining format compatibility across data processing device 140₁ and data processing device 140₂ prior to transfer of multimedia file 262 therebetween, according to one or more embodiments. In one or more embodiments, operation 502 may involve executing an instance of a process (e.g., application 128₁₋₂) on each of data processing device 140₁ and data processing device 140₂. In one or more embodiments, operation 504 may involve setting up PAN 170 through registering or pairing data processing device 140₂ with data processing device 140₁ based on an identifier thereof utilizing a first communication link of PAN 170 to enable data communication therebetween.

In one or more embodiments, operation 506 may involve initiating transfer of multimedia file 262 from memory 104₁ to data processing device 140₂ through the instance of the process executing on data processing device 140₁ utilizing a second communication link of the PAN. In one or more embodiments, the second communication link may be a same communication link as the first communication link or different from the first communication link. In one or more embodiments, operation 508 may involve transmitting, in accordance with the initiation of the transfer, metadata 264 associated with multimedia file 262 from data processing device 140₁ to data processing device 140₂.

In one or more embodiments, operation 510 may then involve determining format compatibility of multimedia file 262 with data processing device 140₂ thereat based on metadata 264 and a list of supported formats (e.g., list 292₂) available in memory 104₂ through a continued execution of the instance of the process on data processing device 140₂.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., data processing device 140₁₋₂). Accordingly, the specification and drawings are to be regarded in an illustrative rather than a restrictive sense.

What is claimed is:

1. A method comprising:
executing an instance of a process on each of a data processing device and another data processing device;
setting up a Personal Area Network (PAN) through one of: registering and pairing the another data processing device with the data processing device based on an identifier thereof utilizing a first communication link of the PAN to enable data communication therebetween;
initiating transfer of a multimedia file from a memory of the data processing device to the another data processing device through the instance of the process executing on the data processing device utilizing a second communication link of the PAN, the second communication link being one of: a same communication link as the first communication link and different from the first communication link;
transmitting, in accordance with the initiation of the transfer, metadata associated with the multimedia file from the data processing device to the another data processing device; and
determining format compatibility of the multimedia file with the another data processing device thereat based on the metadata and a list of supported formats available in a memory of the another data processing device through a continued execution of the instance of the process on the another data processing device.

2. The method of claim 1, comprising determining the format compatibility of the multimedia file with the another data processing device at the data processing device instead of the another data processing device based on transmitting the list of supported formats to the data processing device and the metadata associated with the multimedia file.

3. The method of claim 1,
wherein when the multimedia file is determined to be compatible with the another data processing device, the method further comprises:
transmitting the multimedia file from the data processing device to the another data processing device through a continued execution of the instance of the process on the each of the data processing device and the another data processing device, and
wherein when the multimedia file is determined to be incompatible with the another data processing device, the method further comprises at least one of:
transmitting the list of supported formats to the data processing device for determination of format conversion capability thereat;
performing a format conversion on the multimedia file at the data processing device if the data processing device possesses the format conversion capability; and
one of: transmitting the multimedia file as is to the another data processing device and canceling the transfer thereof if the data processing device does not possess the format conversion capability.

4. The method of claim 3, further comprising leveraging an external data processing device communicatively coupled to at least one of the data processing device and the another data processing device to perform the format conversion on the multimedia file prior to the transfer thereof to the another data processing device.

5. The method of claim 4, wherein the external data processing device is communicatively coupled to the at least one of the data processing device and the another data processing device through one of: the first communication link, the second communication link and a computer network.

6. The method of claim 1, comprising interpreting the list of supported formats through at least one of: the instance of the process executing on the another data processing device and an operating system executing on the another data processing device to determine the format compatibility of the multimedia file with the another data processing device.

7. The method of claim 1, further comprising packaging at least one of: the data processing device and the another data processing device with appropriate library files to account for the data communication across dissimilar operating systems thereof.

8. A non-transitory medium, readable through a data processing device and another data processing device and including instructions embodied therein that are executable through the data processing device and the another data processing device, comprising:
instructions to execute an instance of a process on each of the data processing device and the another data processing device;
instructions to set up a PAN through one of: registering and pairing the another data processing device with the data processing device based on an identifier thereof utilizing a first communication link of the PAN to enable data communication therebetween;
instructions to initiate transfer of a multimedia file from a memory of the data processing device to the another data processing device through the instance of the process executing on the data processing device utilizing a second communication link of the PAN, the second communication link being one of: a same communication link as the first communication link and different from the first communication link;
instructions to transmit, in accordance with the initiation of the transfer, metadata associated with the multimedia file from the data processing device to the another data processing device; and
instructions to determine format compatibility of the multimedia file with the another data processing device thereat based on the metadata and a list of supported formats available in a memory of the another data processing device through a continued execution of the instance of the process on the another data processing device.

9. The non-transitory medium of claim 8, comprising instructions to determine the format compatibility of the multimedia file with the another data processing device at the data processing device instead of the another data processing device based on transmitting the list of supported formats to the data processing device and the metadata associated with the multimedia file.

10. The non-transitory medium of claim 8,
wherein when the multimedia file is determined to be compatible with the another data processing device, the non-transitory medium further comprises instructions to:
transmit the multimedia file from the data processing device to the another data processing device through a continued execution of the instance of the process on the each of the data processing device and the another data processing device, and
wherein when the multimedia file is determined to be incompatible with the another data processing device, the non-transitory medium further comprises instructions to at least one of:
transmit the list of supported formats to the data processing device for determination of format conversion capability thereat;
perform a format conversion on the multimedia file at the data processing device if the data processing device possesses the format conversion capability; and
one of: transmit the multimedia file as is to the another data processing device and cancel the transfer thereof if the data processing device does not possess the format conversion capability.

11. The non-transitory medium of claim 10, further comprising instructions to leverage an external data processing device communicatively coupled to at least one of the data processing device and the another data processing device to perform the format conversion on the multimedia file prior to the transfer thereof to the another data processing device.

12. The non-transitory medium of claim 8, comprising instructions to interpret the list of supported formats through at least one of: the instance of the process executing on the another data processing device and an operating system executing on the another data processing device to determine the format compatibility of the multimedia file with the another data processing device.

13. The non-transitory medium of claim 8, further comprising instructions to package at least one of: the data processing device and the another data processing device with appropriate library files to account for the data communication across dissimilar operating systems thereof.

14. A data communication system comprising:
a data processing device; and
another data processing device, each of the data processing device and the another data processing device executing an instance of a process thereon,
wherein the another data processing device is one of: registered and paired with the data processing device based on an identifier thereof to set up a PAN, a first communication link of the PAN being utilized to enable data communication therebetween,
wherein the instance of the process executing on the data processing device is configured to initiate transfer of a multimedia file from a memory of the data processing device to the another data processing device utilizing a second communication link of the PAN, the second communication link being one of: a same communication link as the first communication link and different from the first communication link,
wherein, in accordance with the initiation of the transfer, the data processing device is configured to transmit metadata associated with the multimedia file to the another data processing device, and
wherein the another data processing device is configured to determine format compatibility of the multimedia file therewith based on the metadata and a list of supported formats available in a memory thereof through a continued execution of the instance of the process thereon.

15. The data communication system of claim 14, wherein the data processing device is configured to determine the format compatibility of the multimedia file with the another data processing device instead of the another data processing device based on the list of supported formats being transmitted thereto and the metadata associated with the multimedia file.

16. The data communication system of claim 14,
wherein when the multimedia file is determined to be compatible with the another data processing device:
the multimedia file is transmitted from the data processing device to the another data processing device through a continued execution of the instance of the process on the each of the data processing device and the another data processing device, and
wherein when the multimedia file is determined to be incompatible with the another data processing device, at least one of:
the list of supported formats is transmitted to the data processing device for determination of format conversion capability thereat,
a format conversion is performed on the multimedia file at the data processing device if the data processing device possesses the format conversion capability, and
one of: the multimedia file is transmitted as is to the another data processing device and the transfer thereof is canceled if the data processing device does not possess the format conversion capability.

17. The data communication system of claim 16, wherein an external data processing device communicatively coupled to at least one of the data processing device and the another data processing device is leveraged to perform the format conversion on the multimedia file prior to the transfer thereof to the another data processing device.

18. The data communication system of claim 17, wherein the external data processing device is communicatively coupled to the at least one of the data processing device and the another data processing device through one of: the first communication link, the second communication link and a computer network.

19. The data communication system of claim 14, wherein the list of supported formats is configured to be interpreted through at least one of: the instance of the process executing on the another data processing device and an operating system executing on the another data processing device to determine the format compatibility of the multimedia file with the another data processing device.

20. The data communication system of claim 14, wherein at least one of: the data processing device and the another data processing device is packaged with appropriate library files to account for the data communication across dissimilar operating systems thereof.
